(19) United States
(12) Patent Application Publication
(10) Pub. No.: US 2025/0128197 A1
(43) Pub. Date: Apr. 24, 2025

(54) Electric Tool and Blocking Monitoring Method

(71) Applicants: Bosch Power Tools (China) Co., Ltd., Hangzhou (CN); Robert Bosch GmbH, Stuttgart (DE)

(72) Inventors: Feng Chen, Hangzhou (CN); Pengbo Wan, Hangzhou (CN)

(21) Appl. No.: 18/914,182

(22) Filed: Oct. 13, 2024

(30) Foreign Application Priority Data
Oct. 19, 2023 (CN) 2023 1136 8827.3

(51) Int. Cl. B01D 46/00; B01D 46/42

(52) U.S. Cl. CPC B01D 46/0086; B01D 46/42; B01D 2201/30

(57) ABSTRACT

An electric tool and a blocking monitoring method is disclosed. The electric tool includes (i) a housing comprising an inlet and an air duct, wherein the air duct is positioned inside the housing and is in communication with the inlet, (ii) an inlet device positioned proximate the inlet so as to at least partially capture particulate matter in a flow of air entering the air duct, (iii) a motor which drives a fan so as to generate a flow of air through the inlet device into the air duct, (iv) a sensor positioned inside the air duct and configured to sense air pressure, and (v) a controller electrically coupled with the sensor. The controller is configured to: record a first air pressure before the motor is activated; record a second air pressure after the motor reaches a predetermined operating rotational speed; and issue a first alarm signal when a difference between the first air pressure and the second air pressure is equal to or greater than a first threshold. The first alarm signal indicates that the inlet device has reached a predetermined degree of blockage.

This application claims priority under 35 U.S.C. § 119 to patent application no. CN 2023 1136 8827.3, filed on Oct. 19, 2023 in China, the disclosure of which is incorporated herein by reference in its entirety.

The present application relates to the field of electric tool operation. More particularly, the present application relates to an electric tool intended to provide improved self-monitoring capabilities. The present application also relates to a blocking monitoring method for the electric tool described above.

### BACKGROUND

Electric tools are typically driven by motors, such as brushless motors. Electric tools are typically used in harsh environments, and dust and debris generated during operation may enter the interior of the electric tool, thereby adversely affecting the operation of the motor. To avoid the effects of dust and debris, an inlet device may be disposed proximate an air inlet. However, with the use of electric tools, dust and debris may accumulate in the inlet device and ultimately cause blockage, resulting in poor ventilation and poor heat dissipation.

### SUMMARY

It is an aim of one aspect of the present application to provide an electric tool capable of providing sustained blocked monitoring capabilities and improving user experience. It is an aim of another aspect of the present application to provide a blocking monitoring method for use in the electric tool described above.

The aims of the present application are achieved through the following technical solutions:

An electric tool, comprising:

a housing including an inlet and an air duct, wherein the air duct is positioned inside the housing and is in communication with the inlet;

an inlet device positioned proximate the inlet so as to at least partially capture particulate matter in a flow of air entering the air duct;

a motor, which drives a fan so as to generate a flow of air through the inlet device into the air duct;

a sensor positioned inside the air duct and configured to sense air pressure; and

a controller electrically coupled with the sensor and configured to:

record a first air pressure before the motor is activated;

record a second air pressure after the motor reaches a predetermined operating rotational speed;

issue a first alarm signal when a difference between the first air pressure and the second air pressure is equal to or greater than a first threshold;

wherein the first alarm signal indicates that the inlet device has reached a predetermined degree of blockage.

### Inlet Device Inlet Device Inlet Device Inlet Device Inlet Device Inlet Device

A blocking monitoring method for an electric tool, comprising the following steps:

activating an electric tool;

sensing and recording a first air pressure inside the electric tool;

activating a motor;

sensing and recording a second air pressure inside the electric tool after a rotational speed of the motor reaches a predetermined value; and

issuing a first alarm signal when a difference between the first air pressure and the second air pressure is equal to or greater than a first threshold;

wherein the first alarm signal indicates that the inlet device has reached a predetermined degree of blockage.

### Inlet Device Inlet Device Inlet Device Inlet Device

### BRIEF DESCRIPTION OF DRAWINGS

The present application will be described in further detail below in conjunction with the accompanying drawings and preferred examples. It will be appreciated by those skilled in the art that these accompanying drawings are drawn for purposes of interpreting preferred examples only, and therefore should not be construed as limiting the scope of the present application. In addition, unless otherwise specified, the accompanying drawings are intended purely to conceptually represent the composition or construction of the described objects and may include exaggerated representations. The accompanying drawings are also not necessarily to scale.

FIG. 1 is a structural schematic diagram of one embodiment of an electric tool of the present application.

FIG. 2 is a partially enlarged view of B portion of FIG. 1.

FIG. 3 is a flow chart of one embodiment of a blocking monitoring method of the present application.

### DETAILED DESCRIPTION

Preferred examples of the present application will be described in detail below with reference to the accompanying drawings. It will be appreciated by those skilled in the art that these descriptions are purely descriptive, exemplary, and should not be construed as limiting the scope of protection of the present application.

First, it should be noted that the terms top, bottom, upward, downward, and other orientation terms referred to herein are defined relative to the orientations in each of the accompanying drawings. These orientations are relative concepts and therefore will vary based on their respective positions and states. Therefore, these or other orientation terms should not be construed as limiting.

In addition, it should be noted that for any single technical feature described or implied in the examples herein or shown or implied in the accompanying drawings, these technical features (or equivalent thereof) can be combined to obtain other examples not explicitly mentioned herein.

It should be noted that in different drawings, the same reference numbers represent the same or substantially similar components.

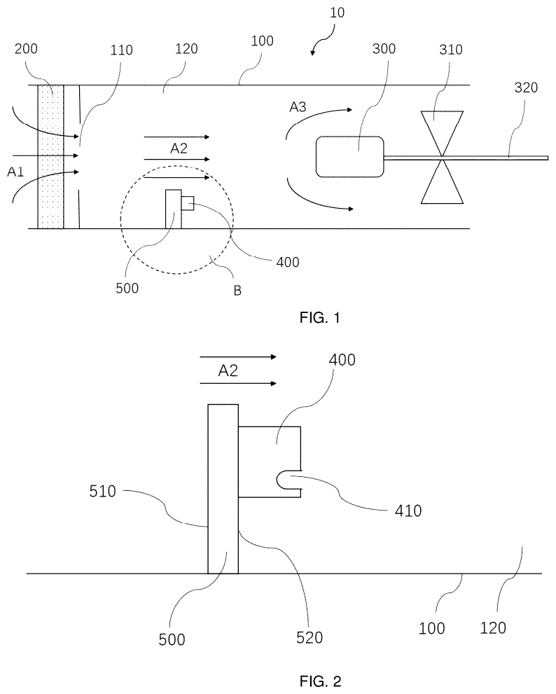

FIGS. 1 and 2 illustrate a local structure of one embodiment of an electric tool of the present application. The electric tool 10 may include: a housing 100, an inlet device 200, a motor 300, a sensor 400, and a controller 500, etc. In an embodiment, the electric tool 10 may be an angled mill. In an embodiment, the electric tool 10 may be an electro-drill, a punch, or any other suitable handheld tool.

The housing 100 may include a space located inside and having an inlet 110 and an air duct 120. It will be readily understood that the housing 100 may have an outlet that is not shown and the outlet and the air duct 120 are in communication so as to form a complete flow channel for air flow. The air duct 120 may extend inside the housing 100 and the inlet 110 may have a reduced shape or may have a reduced size as compared to the size of the housing 100.

The inlet device 200 may be positioned proximate the inlet 110. In the illustrated embodiment, the inlet device 200 may be disposed before the inlet 110. As such, the flow of air entering into the air duct 120 through the inlet 110 will first be filtered by the inlet device 200 and particulate matter such as dust and debris in the flow of air will be at least partially captured by the inlet device 200. With the use of the electric tool 10, more and more particulates are captured in the inlet device 200 and the venting capacity of the inlet device 200 will continue to drop. The inlet device 200 may be a type of filter, such as a removable sponge filter. The inlet device 200 may also be a filter mesh or filter cotton affixed to the housing 100. In an embodiment, the inlet device 200 may be an air inlet grille on the housing 100. The above different types of filters can also be used in combination.

The degree of blockage of the inlet device 200 will be monitored herein. For a new inlet device 200, the degree of blockage may be considered as 0%. At 0% blockage, the structure of the inlet device 200 itself may cause some resistance to air flow, but this is considered a natural obstacle. In this instance, the flow of air through the inlet device 200 may have a certain flow rate for a particular fan rotational speed, or alternatively, have a pass-through capability of 100%. For an inlet device 200 that is fully blocked (i.e., the air flow is completely incapable of passing through), the degree of blockage may be considered to be 100%, or alternatively, having a pass-through capability of 0%. Such an inlet device 200 has an effect similar to that of a separation wall or baffle such that the air flow is completely inaccessible into the air duct 120. The blocking monitoring method of the present application focuses on the inlet device 200 reaching a predetermined degree of blockage. In the following, the predetermined degree of blockage may refer to a degree of blockage of 50%. In an embodiment, the predetermined degree of blockage refers to: for a particular fan rotational speed, the flow of air through the inlet device 200 has a flow rate of 50% as compared to the inlet device 200 of a degree of blockage of 0%, where 50% refers to the pass-through capacity of 100% minus the degree of blockage of 50% resulting in a pass-through capacity of 50%. In a similar manner, the degree of blockage may be defined as 30%, 70%, 80%, etc.

The motor 300 and the fan 310 may be disposed within the air duct 120. For the purpose of heat dissipation, the motor 300 may be positioned upstream of the fan 310 and drive the fan 310 through a shaft 320. The shaft 320 may further be connected to a gearbox or other device, which is not shown, in order to drive the gearbox or other device by the motor 300.

The sensor 400 and the controller 500 may be positioned within the air duct 120 and may be manufactured as integral. The controller 500 may include a first side 510 and a second side 520. The first side 510 may face the inlet device 200 and the second side 520 may face away from the inlet device 200. The sensor 400 may be an air pressure sensor. The sensor 400 may include a sensing opening 410, and the opening direction of the sensing opening 410 may be a direction away from the inlet device 200, or in other words, the orientation of the sensing opening 410 may be a direction of air flow along the air duct 120.

The controller 500 may also be electrically coupled with the sensor 400. The sensor 400 may collect or sense air pressure data inside the air duct 120, and the controller 500 may collect or record sensing data from the sensor 400. Based on the blocking monitoring method detailed below, the controller 500 may determine whether an alarm needs to be issued based on a pressure condition. In an embodiment, the controller 500 may also be electrically coupled with the motor 300 and control the motor 300.

In use, when the motor 300 is activated, it causes the fan 310 to rotate and forms a flow of air inside the air duct 120. Ambient air passes through the inlet device 200 under the action of a pressure difference and then into the air duct 120 through the inlet 110. The direction of air flow as indicated by arrow A1 is formed in this process. Inside the air duct 120, the air flow may travel along generally parallel flow paths, as indicated by arrow A2. In proximity to the motor 300, the air flow may be separated along the directions indicated by arrow A3, providing heat dissipation to the motor 300.

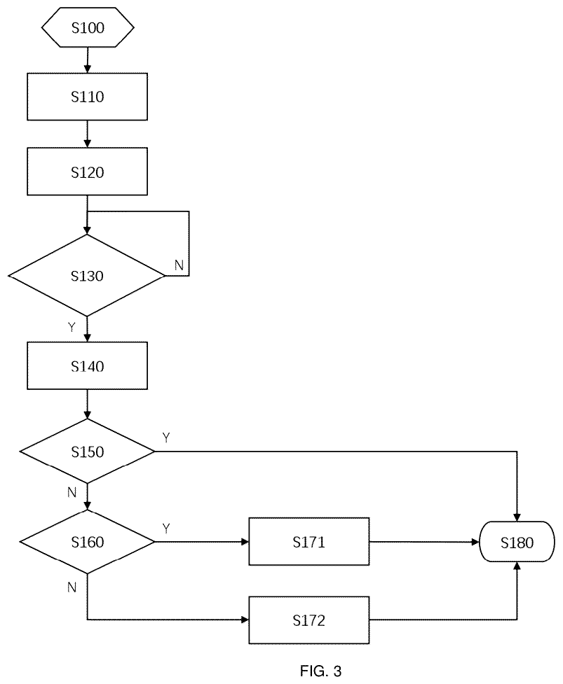

FIG. 3 illustrates one embodiment of a blocking monitoring method of the present application. In an embodiment, one embodiment of the blocking monitoring method according to the present application is performed at each power-on of the electric tool 10. In one embodiment, one embodiment of the blocking monitoring method according to the present application is performed at least once after each power-on of the electric tool 10. In an embodiment, one embodiment of the blocking monitoring method according to the present application is performed by the controller 500.

At step S100, the electric tool 10 is activated. After the electric tool 10 is activated, the sensor 400 may sense air pressure data and record as a first air pressure P1 before the motor 300 is activated (step S110). Subsequently, at step S120, the motor 300 is activated and gradually accelerates until the rotational speed of the motor 300 reaches a predetermined rotational speed. The step S130 will determine whether the rotational speed of the motor 300 has reached a predetermined rotational speed. The letter Y in FIG. 3 represents a determination path of “yes,” and the letter N represents a determination path of “no”. In an embodiment, the predetermined rotational speed may be a rotational speed of the motor 300 at the lowest gear of the electric tool 10. Subsequently, at step S140, the sensor 400 may sense air pressure data and record as a second air pressure P2.

The controller 500 may determine the degree of blockage of the inlet device 200 based on the difference between the first air pressure P1 and the second air pressure P2. The applicant has discovered that the difference between the first air pressure P1 and the second air pressure P2 will increase significantly as the degree of blockage of the inlet device increases. Thus, by calculating a value by distracting the second air pressure P2 from the first air pressure P1, it is possible to determine the degree of blockage of the inlet device 200. It will be readily understood that with the increased degree of blockage, air resupply through the inlet device 200 will become more and more difficult, and the air drawn off the air duct 120 by the motor 300 is not timely resupplied. As a result, air pressure inside the air duct 120 will further decrease.

In FIG. 3, step S150 determines whether the difference between the first air pressure P1 and the second air pressure P2 is less than a first threshold T1. If the difference between the first air pressure P1 and the second air pressure P2 is less than the first threshold T1, the process turns to step S180 to end a single run of the monitoring method. In fact, in the above-described paths, the drop in air pressure relatively small and it is clear that the inlet device 200 does not accumulate blockages that require attention.

In an embodiment, the controller 500 may issue a first alarm signal when the difference between the first air pressure P1 and the second air pressure P2 is equal to or greater than the first threshold T1. In this instance, the first alarm signal may indicate that the inlet device 200 has reached a predetermined degree of blockage, e.g., has reached a degree of blockage of 50%.

At step S150 in FIG. 3, if the difference between the first air pressure P1 and the second air pressure P2 is equal to or greater than the first threshold T1, the process turns to step S160 to determine if the difference between the first air pressure P1 and the second air pressure P2 is less than a second threshold T2.

In an embodiment, the controller 500 may issue a first alarm signal when the difference between the first air pressure P1 and the second air pressure P2 is equal to or greater than the first threshold T1 and less than the second threshold T2 (step S171). When the pressure difference between the first air pressure P1 and the second air pressure P2 is equal to or greater than the second threshold T2, the controller 500 may issue a second alarm signal (step S172). The first alarm signal may indicate that the inlet device 200 has reached a relatively low degree of blockage, such as a degree of blockage of 50%. The second alarm signal may indicate that the inlet device 200 has reached a relatively high degree of blockage, such as a degree of blockage of 80%. After performing step S171 or step S172, the process turns to step S180 to end a single run of the monitoring method.

The first alarm signal and the second alarm signal are issued in one or more of the following manners: sounding through a buzzer or speaker, lighting one or more light emitting diodes, lighting an alarm icon on a human-machine interface of the electric tool 10, displaying an alert on a display of the electric tool 10, alerting on a handheld device (e.g., a smartphone, a tablet, etc.). In an embodiment, the alert may be raised in a smartphone application that is paired with the electric tool 10. The first alarm signal and the second alarm signal may alert the user that: the inlet device 200 has been blocked to a certain extent and needs to be replaced, dusted or cleaned in a timely manner. In an embodiment, the first alarm signal and the second alarm signal may have different manifestations, for example, represented in different colours, represented in different sounds, represented in different text sizes, etc., such that a user may easily distinguish between the first alarm signal and the second alarm signal. For example, the first alarm signal may be displayed with a yellow mark or a yellow light emitting diode, and the second alarm signal may be displayed with a red mark or a red light emitting diode.

The first threshold T1 and the second threshold T2 may be set according to one or more of the following parameters: the model, type and operating environment of the electric tool 10, the rotational speed of the motor 300, the altitude, ambient temperature, ambient humidity, etc. of the electric tool 10. In an embodiment, the first threshold T1 and the second threshold T2 may be calibrated prior to delivery.

The blocking monitoring method of the present application may be run at least once after the electric tool 10 is activated so as to provide the user with notification information for cleaning the inlet device 200.

The electric tool and the blocking monitoring method of the present application have the advantages of simplicity and reliability, ease of implementation, ease of use, etc., and can provide improved blocking monitoring capabilities. The ease of operation and user experience of the electric tool are improved by employing the electric tool and the blocking monitoring method of the present application.

This specification discloses the present application with reference to the accompanying drawings and also enables those skilled in the art to implement the present application, including the manufacture and use of any device or system, the selection of suitable materials, and the use of any combination of methods. The scope of the present application is defined by the technical solutions for which protection is sought and includes other embodiments that may be conceivable to those skilled in the art. As long as such other embodiments comprise structural elements that do not differ from the literal description of the technical solutions for which protection is sought or comprise equivalent structural elements that do not substantially differ from the literal description of the technical solutions for which protection is sought, such other embodiments should be considered within the scope of protection defined by the technical solutions for which protection is sought under the present application.

What is claimed is:

1. An electric tool, comprising:
a housing including an inlet and an air duct, wherein the air duct is positioned inside the housing and is in communication with the inlet;
an inlet device positioned proximate the inlet so as to at least partially capture particulate matter in a flow of air entering the air duct;
a motor configured to drive a fan so as to generate a flow of air through the inlet device into the air duct;
a sensor positioned inside the air duct and configured to sense air pressure; and
a controller electrically coupled with the sensor and configured to:
record a first air pressure before the motor is activated;
record a second air pressure after the motor reaches a predetermined operating rotational speed;
issue a first alarm signal when a difference between the first air pressure and the second air pressure is equal to or greater than a first threshold,
wherein the first alarm signal indicates that the inlet device has reached a predetermined degree of blockage.

2. The electric tool according to claim 1, wherein:
the controller is further configured to:
issue a first alarm signal when the difference between the first air pressure and the second air pressure is equal to or greater than the first threshold and less than a second threshold, and
issue a second alarm signal when the difference between the first air pressure and the second air pressure is equal to or greater than the second threshold, and
the first alarm signal indicates that the inlet device has reached a relatively low degree of blockage and the second alarm signal indicates that the inlet device has reached a relatively high degree of blockage.

3. The electric tool according to claim 1, wherein:
the motor and the fan are positioned within the air duct,
the controller is positioned between the inlet device and the fan,
the controller includes a first side and a second side,
the first side faces toward the inlet device,
the second side faces away from the inlet device,
the sensor is disposed on the second side, and
the sensor includes a sensing opening oriented away from the inlet device.

4. The electric tool according to claim 1, wherein the first alarm signal and the second alarm signal are issued in one or more of the following manners:
sounding through a buzzer or speaker,
lighting one or more light emitting diodes,
lighting an alarm icon on a human-machine interface of the electric tool,
displaying an alert on a display of the electric tool, and
alerting on a handheld device.

5. The electric tool according to claim 1, wherein:
the inlet device comprises one or more of the following types: a filter mesh, a filter cotton, a removable filter, an inlet grille, or a combination thereof, and
the first threshold and the second threshold are determined based on one or more of the following parameters: a rotational speed, an altitude, an ambient temperature, and an ambient humidity of the motor.

6. A blocking monitoring method for an electric tool, comprising:
activating an electric tool;
sensing and recording a first air pressure inside the electric tool;
activating a motor;
sensing and recording a second air pressure inside the electric tool after a rotational speed of the motor reaches a predetermined value; and
issuing a first alarm signal when a difference between the first air pressure and the second air pressure is equal to or greater than a first threshold,
wherein the first alarm signal indicates that the inlet device has reached a predetermined degree of blockage.

7. The blocking monitoring method according to claim 6, wherein:
the first alarm signal is issued when the difference between the first air pressure and the second air pressure is equal to or greater than the first threshold and less than a second threshold,
a second alarm signal is issued when the pressure difference between the first air pressure and the second air pressure is equal to or greater than the second threshold, and
the first alarm signal indicates that the inlet device has reached a relatively low degree of blockage and the second alarm signal indicates that the inlet device has reached a relatively high degree of blockage.

8. The blocking monitoring method according to claim 6, wherein:
the first air pressure and the second air pressure are sensed by a sensor disposed in an air duct of the electric tool,
the inlet device is disposed in the air duct so as to at least partially capture particulate matter in a flow of air entering the air duct,
the sensor includes a sensing opening, and
the sensing opening is oriented substantially (i) the same as a flow direction of the air flow in the air duct, and (ii) away from the inlet device.

9. The blocking monitoring method according to claim 6, wherein the first alarm signal and the second alarm signal are issued in one or more of the following manners:
sounding through a buzzer or speaker,
lighting one or more light emitting diodes,
lighting an alarm icon on a human-machine interface of the electric tool,
displaying an alert on a display of the electric tool, and
alerting on a handheld device.

10. The blocking monitoring method according to claim 6, wherein:
the inlet device includes one or more of the following types: a filter mesh, a filter cotton, a removable filter, an inlet grille, or a combination thereof, and
the first threshold and the second threshold are determined based on one or more of the following parameters: a rotational speed, an altitude, an ambient temperature, and an ambient humidity of the motor.
